(19) United States
(12) Patent Application Publication
(10) Pub. No.: US 2022/0137303 A1
(43) Pub. Date: May 5, 2022

(54) FERRULE AND FERRULE MANUFACTURING METHOD

(71) Applicant: Fujikura Ltd., Tokyo (JP)

(72) Inventors: Takahito Otomitsu, Chiba (JP); Shuhei Kanno, Chiba (JP); Kansei Shindo, Chiba (JP)

(73) Assignee: Fujikura Ltd., Tokyo (JP)

(21) Appl. No.: 17/430,572

(22) PCT Filed: Jan. 15, 2020
(86) PCT No.: PCT/JP2020/000939

§ 371 Date: Aug. 12, 2021

(30) Foreign Application Priority Data
May 13, 2019 (JP) 2019-090634

(51) Int. Cl. G02B 6/38

(52) U.S. Cl. CPC G02B 6/3818; G02B 6/3882; G02B 6/3855

(57) ABSTRACT

A ferrule includes a ferrule body and a film. The ferrule body has a connecting end face that connects to another ferrule, a fiber hole into which an optical fiber inserts, and a recessed portion with a bottom surface that is recessed from the connecting end face at a depth. The film is disposed to cover the fiber hole that is open at a bottom surface of the recessed portion, and the film is thinner than a depth of the recessed portion.

### TECHNICAL FIELD

The present invention relates to a ferrule and a ferrule manufacturing method.

### BACKGROUND

A ferrule specified in JIS C 5981 (F12 type connectors for optical fiber ribbons: MT connectors) is known as a ferrule for holding an end portion of an optical fiber. With this type of ferrule, the connecting end faces of a pair of opposing ferrules are abutted against each other in order to achieve physical connection (Physical Contact) between the end faces of optical fibers that are exposed at the connecting end faces of the ferrules.

Patent Document 1 describes a ferrule that is arranged with a lens (a lensed ferrule). With this type of lensed ferrule, the end faces of optical fibers do not physically contact each other. Also, in the description of Patent Document 2, a spacer having an opening is arranged at the end face of a ferrule, and the end faces of optical fibers are not physically brought into contact with each other due to the separation from the partner ferrule provided by the spacer.

### PATENT DOCUMENT

[Patent Document 1] US 2012/0093462

[Patent Document 2] JP 2017-142373A

In the case of PC-type ferrules that physically connect the end faces of optical fibers, if dust sticks to the end faces of the optical fibers, the end faces of the optical fibers are damaged and connection loss increases. Also, in the case of PC-type ferrules, the end face of one optical fiber needs to be pressed against the partner optical fiber with a predetermined force, thus making it necessary to set a relatively strong force for pressing one ferrule toward the partner ferrule.

In the case of a lensed ferrule as described in Patent Document 1, unlike a PC-type ferrule, the lens is arranged in front of the end face of the optical fiber, thus making it possible to suppress damage to the end face of the optical fiber. Also, in the case of a lensed ferrule, unlike a PC-type ferrule, the end faces of the optical fibers do not physically come into contact with each other, thus making it possible to set a relatively weak force for pressing one ferrule toward the partner ferrule. On the other hand, in the case of a lensed ferrule, it is necessary to accurately align the positions of the optical fiber and the lens. For this reason, the number of parts that require alignment work increases, and very little position error is allowed for components. (Also, in the case of a lensed ferrule, the MFD (Mode Field Diameter) of the optical signal is expanded by the lens of one ferrule, and therefore the MFD needs to be focused by the lens of the other ferrule, thus requiring the partner ferrule to also be a lensed ferrule.)

In the case of the ferrule described in Patent Document 2, the end face of the optical fiber is exposed from the opening of the spacer (the opening through which the optical signal passes), and therefore there is a risk that the end face of the optical fiber may be damaged. Also, in the case of the ferrule described in Patent Document 2, there is a risk that transmission loss of the optical signal may increase.

### SUMMARY

One or more embodiments of the present invention provide a novel ferrule capable of suppressing damage to an end face of an optical fiber and also suppressing transmission loss of an optical signal.

One or more embodiments of the present invention provide a ferrule comprising: a ferrule body having a connecting end face configured to be connected to another ferrule, a fiber hole into which an optical fiber is to be inserted, and a recessed portion that is recessed from the connecting end face; and a film that is arranged so as to cover the fiber hole that is open at a bottom surface of the recessed portion, wherein the film is thinner than a depth of the recessed portion.

One or more embodiments of the present invention provide a ferrule comprising: a ferrule body having a connecting end face that connects to another ferrule, a fiber hole into which an optical fiber is to be inserted, and a recessed portion that is recessed from the connecting end face; and a film that is arranged so as to cover the fiber hole that is open at a bottom surface of the recessed portion, an outward surface of the film being recessed from the connecting end face.

Other features of embodiments of the present invention will become apparent from the following description of the present specification and the drawings.

According to one or more embodiments, it is possible to suppress damage to an end face of an optical fiber and also suppress transmission loss of an optical signal.

### BRIEF DESCRIPTION OF THE DRAWINGS

FIG. 1A is a perspective view of a ferrule 100 according to one or more embodiments. FIG. 1B is an exploded view of the ferrule 100 according to one or more embodiments.

FIG. 2A is a cross-sectional view of the ferrule 100 according to one or more embodiments. FIG. 2B is an enlarged cross-sectional view of the vicinity of a connecting end face 10B of the ferrule 100.

FIGS. 3A and 3B are illustrative views of a simulation of connection loss according to one or more embodiments.

FIGS. 4A and 4B are illustrative views of the connection loss simulation in a comparative example.

FIG. 5 is a diagram illustrating a state where the ferrule 100 of one or more embodiments has been connected to a PC-type ferrule 100′.

FIG. 6 is a flowchart of a manufacturing process for a ferrule with a fiber according to one or more embodiments.

FIG. 7A is a diagram illustrating the processing of steps S002 and S003. FIG. 7B is a diagram illustrating the processing of steps S006 and S007.

FIG. 8 is a diagram illustrating the processing of steps S002 and S003 in a variation.

FIG. 9 is an enlarged cross-sectional view of the vicinity of the connecting end face 10B of the ferrule 100 according to one or more embodiments.

### DETAILED DESCRIPTION

At least the following matter will become apparent from the following description of the present specification and the drawings.

A ferrule will become clear comprising: a ferrule body having a connecting end face configured to be connected to another ferrule, a fiber hole into which an optical fiber is to be inserted, and a recessed portion that is recessed from the connecting end face; and a film that is arranged so as to cover the fiber hole that is open at a bottom surface of the recessed portion, wherein the film is thinner than a depth of the recessed portion. According to this ferrule, damage to the end face of the optical fiber can be suppressed, and transmission loss of an optical signal can be suppressed.

In one or more embodiments, the film has an antireflection film. According to this configuration, it is possible to reduce transmission loss and return loss of an optical signal.

In one or more embodiments, the connecting end face is inclined with respect to a plane perpendicular to an optical axis of the optical fiber to be inserted into the fiber hole, and the bottom surface of the recessed portion and the film are arranged parallel to the connecting end face. According to this configuration, the film can be arranged in the recessed portion such that the film does not protrude from the connecting end face of the ferrule body.

In one or more embodiments, an optical axis of an optical fiber of the another ferrule is arranged on an extension line of the optical axis of the optical fiber to be inserted into the fiber hole. According to this configuration, optical fibers can be optically connected to each other even if the connection target is a PC-type ferrule.

In one or more embodiments, the ferrule body has a pair of guide holes into which guide pins are to be inserted, and a plurality of the fiber holes are arranged point-symmetrically about a center point between the pair of guide holes. According to this configuration, optical fibers can be optically connected to each other even if the connection target is a PC-type ferrule.

A ferrule will become clear comprising: a ferrule body having a connecting end face configured to be connected to another ferrule, a fiber hole into which an optical fiber is to be inserted, and a recessed portion that is recessed from the connecting end face; and a film that is arranged so as to cover the fiber hole that is open at a bottom surface of the recessed portion, an outward surface of the film being recessed from the connecting end face. According to this ferrule, damage to the end face of the optical fiber can be suppressed, and transmission loss of an optical signal can be suppressed.

A ferrule manufacturing method will become clear comprising: preparing a ferrule body that has a connecting end face configured to be connected to another ferrule, a fiber hole into which an optical fiber is to be inserted, and a recessed portion that is recessed from the connecting end face; placing a first jig against a bottom surface of the recessed portion of the ferrule body; inserting the optical fiber into the fiber hole and placing an end face of the optical fiber against the first jig; fixing the optical fiber to the ferrule body in a state where the end face of the optical fiber has been placed against the first jig; and attaching a film to the bottom surface of the recessed portion such that the film covers the fiber hole that is open at the bottom surface of the recessed portion after the first jig has been removed. According to this manufacturing method, it is possible to provide a novel ferrule capable of suppressing damage to an end face of an optical fiber and also suppressing transmission loss of an optical signal.

In one or more embodiments, the attaching the film includes: preparing a second jig to which the film has been detachably attached; affixing the film to the bottom surface of the recessed portion with use of the second jig; and removing the second jig while allowing the film to detach from the second jig. According to this configuration, deformation of the film can be suppressed, and therefore damage to the film can be suppressed.

In one or more embodiments, the film has an antireflection film. In this case, affixing the film with use of the second jig is particularly effective.

One or more embodiments of the present disclosure further comprise: detachably attaching the film to an end face of a protruding portion of the second jig; and pressing the film by the second jig against the bottom surface of the recessed portion via the protruding portion. According to this configuration, the film arranged in the recessed portion does not protrude from the connecting end face of the ferrule, and the surface of the film can be arranged at a position that is recessed from the connecting end face of the ferrule.

Configuration of ferrule 100

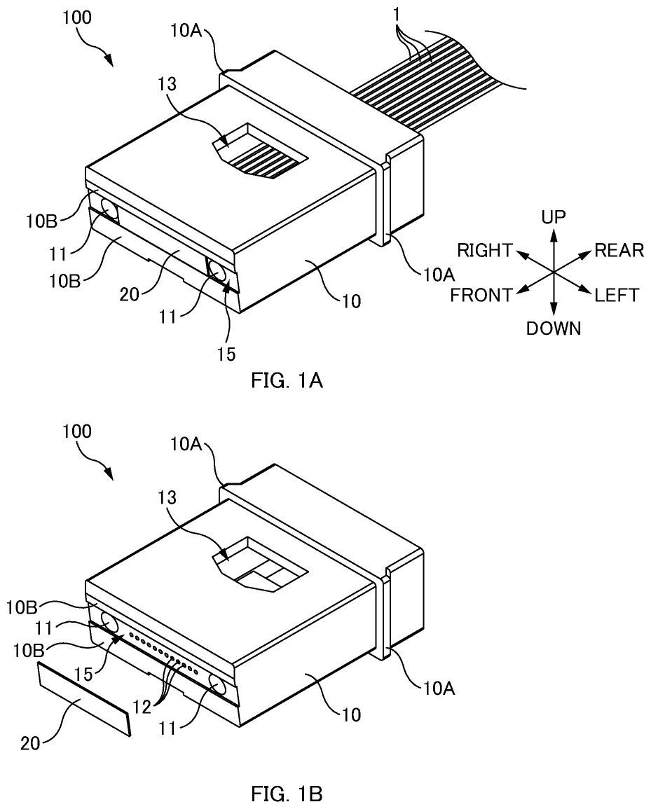

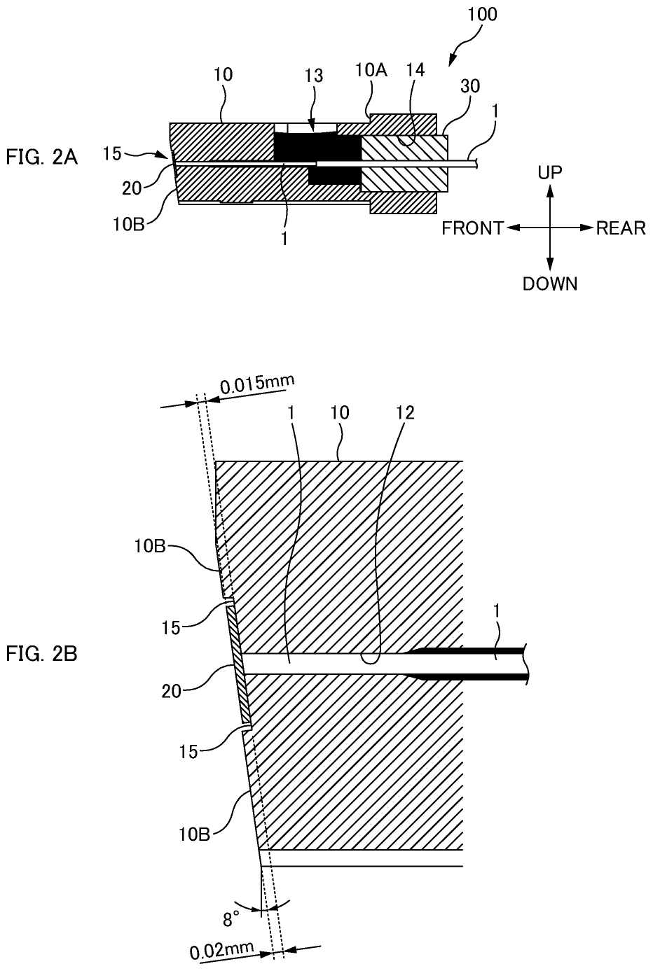

FIG. 1A is a perspective view of a ferrule 100 according to one or more embodiments. FIG. 1B is an exploded view of the ferrule 100 according to one or more embodiments. Note that FIG. 1A shows a ferrule 100 to which an optical fiber 1 has been attached (a ferrule with a fiber). Also, an adhesive is not shown in FIG. 1A. FIG. 2A is a cross-sectional view of the ferrule 100 according to one or more embodiments. FIG. 2B is an enlarged cross-sectional view of the vicinity of a connecting end face 10B of the ferrule 100.

The directions used in the following description are defined as shown in FIG. 1A. The extending direction of a fiber hole 12 is the “front-rear direction”, the side corresponding to the connecting end face 10B of the ferrule 100 is the “front” side, and the side opposite thereto is the “rear” side. In other words, the optical axis direction of the optical fiber 1 inserted into the fiber hole 12 is the “front-rear direction”, and the side corresponding to the end face of the optical fiber 1 is the “front” side. Also, the thickness direction of the ferrule 100 is the “up-down direction”, the side corresponding to the opening of an adhesive filling portion 13 is the “upward” side, and the side opposite thereto is the “downward” side. Also, the width direction of the ferrule 100 is the “left-right direction”, the right side when viewing the front side from the rear side is the “right” side, and the side opposite thereto is the “left” side. Note that the direction in which two guide holes 11 are adjacent to each other is the “left-right direction”, and the direction in which fiber holes 12 are adjacent to each other is the “left-right direction”.

The ferrule 100 is a member that holds end portions of optical fibers 1. In one or more embodiments, the end portions of 12 single-mode optical fibers are held by the ferrule 100. However, the number of optical fibers 1 held by the ferrule 100 is not limited to 12. Also, the optical fibers 1 are not limited to being single-mode optical fibers. The ferrule 100 of one or more embodiments is a structure (ferrule structure) that includes a ferrule body 10 and a film 20.

The ferrule body 10 is a member that holds end portions of the optical fibers 1. The ferrule body 10 is integrally molded using resin, for example. A flange portion 10A that protrudes outward is formed in a rear portion of the ferrule body 10. The front end face of the ferrule body 10 is a connecting end face 10B for connection to (contact with) another ferrule (not shown). In one or more embodiments, the connecting end face 10B of the ferrule 100 is an inclined end face that is inclined by approximately 8 degrees with respect to a plane perpendicular to the optical axis of the optical fibers 1 (a plane that is perpendicular to the front-rear direction and is parallel with the up-down direction and the left-right direction). However, the connecting end face 10B of the ferrule 100 is not limited to being an inclined end face and may be a face that is perpendicular to the optical axis of the optical fibers 1.

The ferrule body 10 includes a pair of guide holes 11, a plurality of fiber holes 12, an adhesive filling portion 13, an introduction hole 14, and a recessed portion 15.

The guide holes 11 are holes for insertion of guide pins (not shown). Guide pins are arranged in advance in the guide holes 11 of the ferrule 100 on the male side, and the end portions of the guide pins protrude from the openings of the guide holes 11. By inserting the guide pins of the ferrule 100 on the male side into the guide holes 11 of the ferrule 100 on the female side, the ferrules 100 are aligned with each other. The guide holes 11 are formed extending parallel to the front-rear direction and pass through the ferrule body 10 in the front-rear direction. The guide holes 11 are open on the front side of the ferrule 100 (a bottom surface of the recessed portion 15). The pair of guide holes 11 are formed with a gap therebetween in the left-right direction. A plurality of fiber holes 12 are arranged between the pair of guide holes 11.

The fiber holes 12 are holes into which the end portions of the optical fibers 1 are inserted. The fiber holes 12 are also holes for positioning the optical fibers 1. An optical fiber 1 (bare fiber) from which the coating has been removed is inserted into each of the fiber holes 12. The fiber holes 12 are formed extending parallel to the front-rear direction. The fiber holes 12 are open on the front side of the ferrule 100 (the bottom surface of the recessed portion 15). Also, the fiber holes 12 are in communication with the adhesive filling portion 13 and the introduction hole 14. The plurality of fiber holes 12 are arranged side-by-side in the left-right direction.

The adhesive filling portion 13 is a hollow portion that is to be filled with an adhesive. An opening for filling the adhesive filling portion 13 with the adhesive is formed in the upper surface of the ferrule 100. The front portion of the adhesive filling portion 13 is in communication with the fiber holes 12, and the rear portion is in communication with the introduction hole 14. The optical fibers 1 are introduced through the introduction hole 14, pass through the adhesive filling portion 13, and are inserted into the fiber holes 12. By filling the adhesive filling portion 13 with the adhesive, the optical fibers 1 are fixed to the ferrule 100.

The introduction hole 14 is a hole for introducing the optical fibers 1 into the ferrule 100 so as to then be inserted into the fiber holes 12 (see FIG. 2B). The introduction hole 14 is formed in a rear portion of the ferrule 100. The introduction hole 14 is also a hole for attaching a boot 30 that protects the optical fibers 1. The introduction hole 14 is open at the rear end face of the ferrule 100. The introduction hole 14 is in communication with the adhesive filling portion 13.

The recessed portion 15 is a portion that is recessed from the connecting end face 10B (front end face) of the ferrule 100. The recessed portion 15 is shaped as a groove that extends along the left-right direction. The recessed portion 15 is formed so as to be slightly deeper than the thickness of the film 20. In one or more embodiments, the depth of the recessed portion 15 (the distance between the surface of the connecting end face 10B and the bottom surface of the recessed portion 15) is 0.02 mm (in contrast, the thickness of the film 20 is 0.015 mm). The fiber holes 12 are open at the bottom surface of the recessed portion 15. Also, the end faces of the optical fibers 1 inserted into the fiber holes 12 are arranged at the bottom surface of the recessed portion 15. In one or more embodiments, the recessed portion 15 extends between the left and right edges of the connecting end face 10B of the ferrule 100, and therefore the guide holes 11 are open at the bottom surface of the recessed portion 15. However, a configuration is possible in which the recessed portion 15 is formed in only the portion where the fiber holes 12 are formed, and the recessed portion 15 is not formed in the portions where the guide holes 11 are formed (in this case, the guide holes 11 are open at the connecting end face 10B of the ferrule 100).

The bottom surface of the recessed portion 15 extends parallel to the connecting end face 10B of the ferrule 100. In one or more embodiments, the connecting end face 10B of the ferrule 100 is an inclined end face, and therefore the bottom surface of the recessed portion 15 is also inclined approximately 8 degrees with respect to a plane perpendicular to the optical axis of the optical fiber 1 (a plane that is perpendicular to the front-rear direction and is parallel to the up-down direction and the left-right direction).

The film 20 is a member that is arranged on the front side of the end faces of the optical fibers 1. The film 20 can transmit optical signals transmitted by the optical fibers 1. In one or more embodiments, the film 20 is made of a transparent polyimide film, but the material of the film 20 is not limited to this.

The film 20 is arranged in the recessed portion 15. The film 20 is arranged so as to cover the fiber holes 12 that are open at the bottom surface of the recessed portion 15. In other words, the film 20 is arranged so as to cover the end faces of the optical fibers 1 that have been inserted into the fiber holes 12. The inward (rear) surface of the film 20 is arranged so as to face the end faces of the optical fibers 1. The inward surface of the film 20 is affixed to the bottom surface of the recessed portion 15, and the film 20 is thus fixed to the recessed portion 15. The outward surface of the film 20 is an entrance/exit surface through which optical signals enter/exit the another ferrule.

In one or more embodiments, the outward surface of the film 20 is coated with an antireflection film 21. For example, the antireflection film 21 is an AR coating film formed by a stack of two types of thin films that have different refractive indexes. Forming the antireflection film 21 on the film 20 makes it possible to reduce transmission loss and return loss of optical signals.

The film 20 is thinner than the depth of the recessed portion 15. For this reason, when arranged in the recessed portion 15, the film 20 does not protrude from the connecting end face 10B of the ferrule 100, and the surface of the film 20 is recessed from the connecting end face 10B of the ferrule 100. As a result, even if the connecting end face 10B of the ferrule 100 is abutted against the connecting end face of the another ferrule, the film 20 does not come into contact with the another ferrule (e.g., the connecting end face or the film of the another ferrule), and thus damage to the film 20 can be suppressed. Note that in one or more embodiments, the thickness of the film 20 is 0.015 mm (in contrast, the depth of the recessed portion 15 is 0.02 mm).

The film 20 is a strip-shaped member that is elongated in the left-right direction. The openings of the fiber holes 12 are covered by one film 20. In other words, the end faces of the optical fibers 1 are covered by one film 20.

The film 20 is a member that is thinner than a flat glass plate. For this reason, in one or more embodiments, the end faces of the optical fibers 1 can be arranged closer to the end faces of the optical fibers 1 of the another ferrule, thus making it possible to suppress transmission loss.

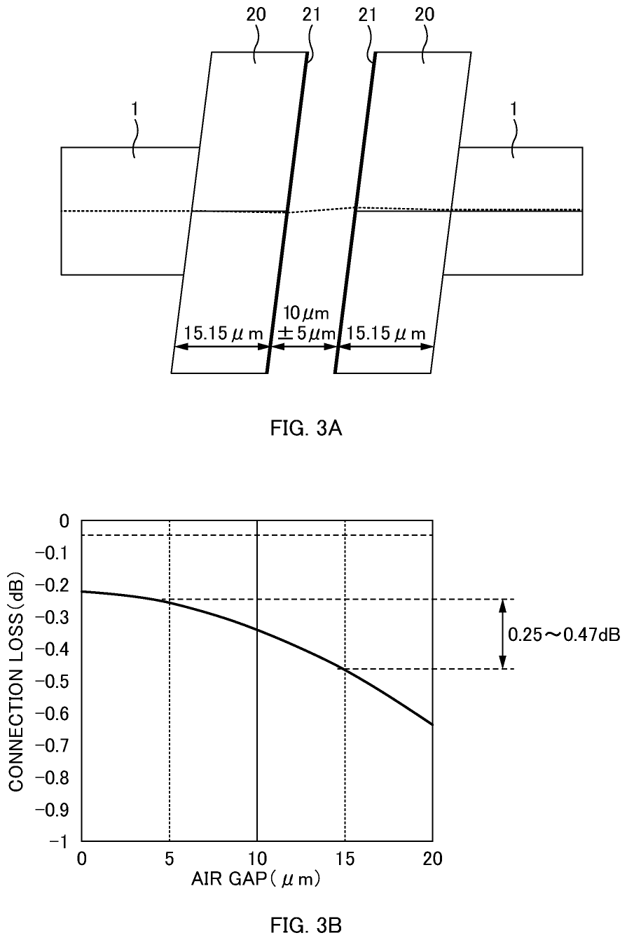

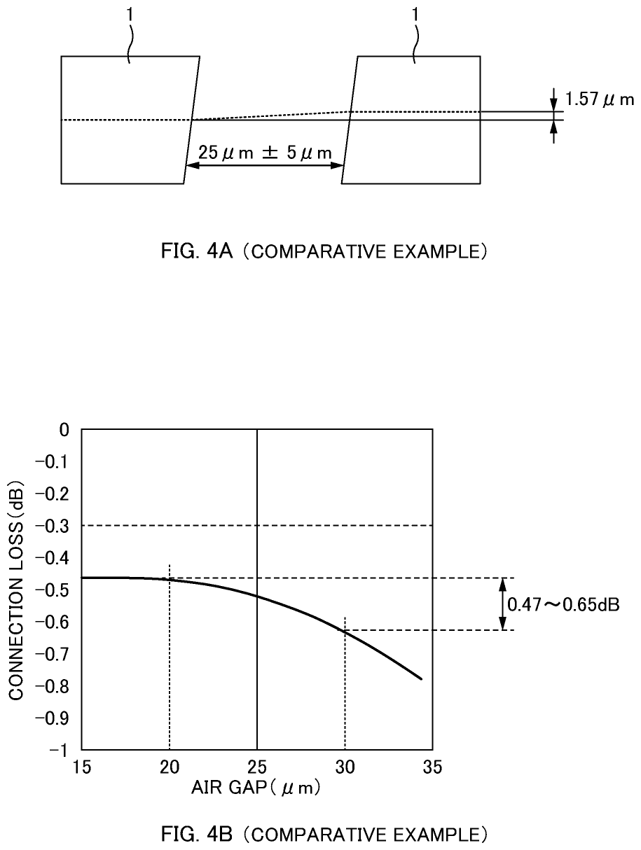

FIGS. 3A and 3B are illustrative views of a simulation of connection loss in one or more embodiments. FIGS. 4A and 4B are illustrative views of the connection loss simulation in a comparative example.

As shown in FIG. 3A, in one or more embodiments, the film 20 is arranged on the front side of the end faces of the optical fibers 1, and two ferrules 100 having this configuration (not shown in FIG. 3A) are arranged to face each other. The optical signal connection loss was calculated using a refractive index of 1.467 for the optical fiber 1 (core) and a refractive index of 1.64 for the film 20 (material: polyimide). In one or more embodiments, the thickness of the film 20 is 15.15 μm, and the antireflection film 21 (AR coating film) that reduces optical signal reflection to 0.3% or less is formed on the end face of the film 20. Note that in one or more embodiments, the design value of the air gap (distance between the end faces of films 20) is 10 μm plus or minus 5 μm. In one or more embodiments, the influence of optical signal refraction is small because the air gap is small, and therefore the optical axes of the optical fibers 1 are not offset (the optical axis of one optical fiber 1 is located on an extension line of the optical axis of the other optical fiber 1).

Also, as shown in FIG. 3B, in the comparative example, the end faces of optical fibers 1 are arranged facing each other without the films 20 being located therebetween. In the comparative example, it is assumed that the optical signal reflection is 3.6% at the end faces of the optical fibers 1. Also, in the comparative example, the design value of the air gap (distance between the end faces of the optical fibers 1) is 25 μm plus or minus 5 μm. In the comparative example, because the air gap is large, the optical axes of the optical fibers 1 are offset by 1.57 μm in the up-down direction due to optical signal refraction.

FIGS. 3B and 4B show graphs of connection loss simulation results. The horizontal axis in the graphs shows the size of the air gap. The vertical axis in the graphs shows connection loss (dB). In one or more embodiments, if the air gap was within the design value range, the connection loss was 0.25 to 0.47 dB. In the comparative example, if the air gap was within the design value range, the connection loss was 0.47 dB to 0.65 dB. Therefore, in one or more embodiments, the connection loss can be lower than in the comparative example. Note that in one or more embodiments, when the air gap is 20 μm or more, the connection loss is higher than that in the comparative example. The reason for this is that the optical axes of the optical fibers are not offset in the up-down direction in one or more embodiments.

In one or more embodiments, as shown in FIG. 3A, even if the positions of the optical axes of the optical fibers 1 are not offset in the up-down direction (thickness direction), the end face of one optical fiber 1 can be arranged close to the end face of the optical fiber 1 of the another ferrule, and therefore connection loss can be suppressed. Because the positions of the optical axes of the optical fibers 1 are not offset in the up-down direction (thickness direction), when the ferrule 100, according to one or more embodiments, is connected to the another ferrule, the optical axis of the optical fiber 1 of the another ferrule is arranged on an extension line of the optical axis of the optical fiber 1 of the ferrule 100.

In order to prevent the positions of the optical axes of the optical fibers 1 from being offset in the up-down direction (thickness direction), that is to say in order for the optical axis of the optical fiber 1 of the another ferrule to be arranged on an extension line of the optical axis of the optical fiber 1 of the ferrule of one or more embodiments, when the ferrule body 10 is viewed from the front side, the fiber holes 12 are arranged point-symmetrically about the center point between the pair of guide holes 11. If the fiber holes 12 are arranged in one row in the left-right direction, the center positions of the fiber holes 12 in the up-down direction match the positions of the guide holes 11 in the up-down direction. Also, if the fiber holes 12 are arranged in one row in the left-right direction, the fiber holes 12 are arranged line-symmetrically with respect to a straight line that connects the centers of the pair of guide holes 11. However, the fiber holes 12 are not limited to the case of being arranged in one row in the left-right direction and may be arranged in two or more rows.

In one or more embodiments, taking advantage of the fact that the air gap with the another ferrule is small and the fact that there is no offset between the positions of the optical axes of the optical fibers 1, optical fibers can be optically connected to each other even if the another ferrule is a PC-type ferrule. As described above, according to the ferrule 100 of one or more embodiments, the connection to the another ferrule is not limited to being the ferrule 100 of one or more embodiments, and may be a PC-type ferrule instead.

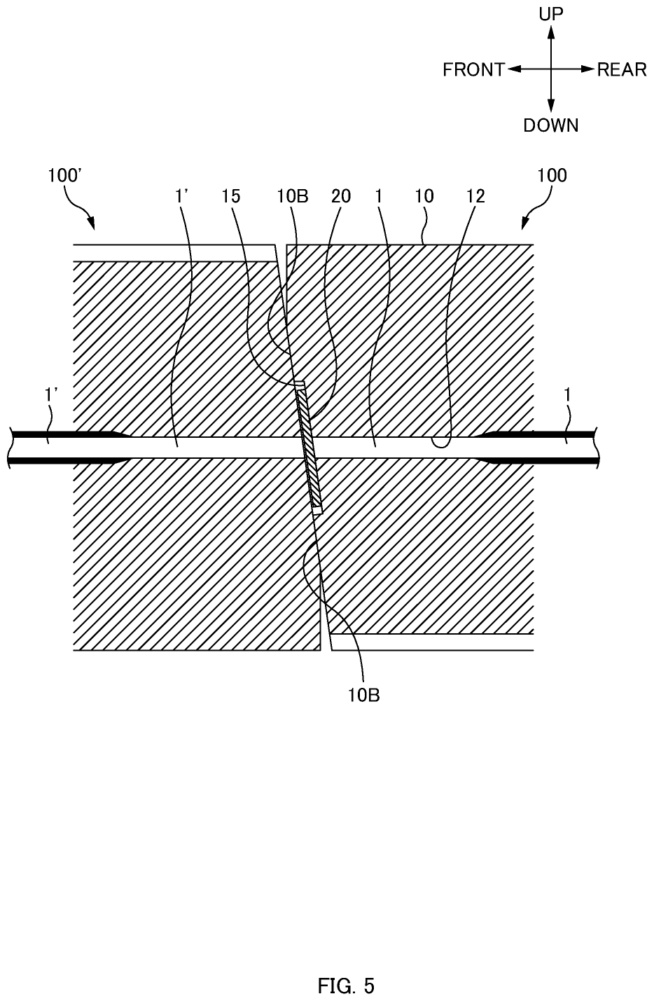

FIG. 5 is a diagram illustrating a state where the ferrule 100 of one or more embodiments has been connected to a PC-type ferrule 100′.

In the another ferrule 100′ (here, a PC-type ferrule) as well, the connecting end face is an inclined end face that is inclined by approximately 8 degrees with respect to a plane perpendicular to the optical axis of an optical fiber 1′. In the another ferrule 100′, a fiber hole is open at the connecting end face, and the end face of the optical fiber 1′ is exposed from the opening of the fiber hole. Because the end face of the optical fiber 1′ of the another ferrule 100′ has been obliquely polished along with the connecting end face, it is arranged on substantially the same plane as the connecting end face. Note that in the case of the another ferrule 100′ (PC-type ferrule), it is envisioned that the end faces of two optical fibers 1′ are physically connected to each other, and therefore the position of the optical axis of the optical fiber 1′ is not offset in the up-down direction.

As shown in FIG. 5, when the ferrule 100 of one or more embodiments is connected to the PC-type ferrule 100′, for both of the ferrules, the position of the optical axis of the optical fiber is not offset in the up-down direction (thickness direction), and therefore the optical axis of one optical fiber is arranged on an extension line of the optical axis of the other optical fiber. Even if the ferrule 100 of one or more embodiments is connected to the PC-type ferrule 100′, the end face of the optical fiber 1 can be arranged close to the end face of the optical fiber 1′ of the another ferrule 100′, and furthermore the air gap with the another ferrule 100′ (in this case, the distance between the end face of the optical fiber 1′ of the another ferrule 100′ and the end face of the film 20) is small and the influence of optical signal refraction is small, and therefore the optical fibers can be optically connected with little connection loss. Note that even if the ferrule 100 of one or more embodiments is connected to the PC-type ferrule 100′, the film 20 does not come into contact with the another ferrule (e.g., the connecting end face of the another ferrule or the end face of the optical fiber), and therefore damage to the film 20 can be suppressed.

As described above, the ferrule 100 of one or more embodiments includes the ferrule body 10 and the film 20. The ferrule body 10 has the connecting end face 10B, the fiber holes 12, and the recessed portion 15 that is recessed from the connecting end face 10B. In one or more embodiments, the film 20 is arranged so as to cover the fiber holes 12 that are open at the bottom surface of the recessed portion 15. Accordingly, the end face of the optical fiber 1 is covered with the film 20, and therefore damage to the end face of the optical fiber 1 can be suppressed. Also, in one or more embodiments, the film 20 is formed thinner than the depth of the recessed portion 15. As a result, when the ferrule 100 is connected to the another ferrule (when the connecting end face 10B of the ferrule body 10 is brought into contact with the connecting end face of the another ferrule), the film 20 does not come into contact with the another ferrule, and therefore damage to the film 20 can be suppressed. Also, in one or more embodiments, the film 20 is arranged on the front side of the end face of the optical fiber 1, and therefore the air gap between the ferrule and the another ferrule can be smaller than that in the comparative example in which the film 20 is not arranged (see FIGS. 4A and 4B), and therefore connection loss can be suppressed.

Also, in one or more embodiments, the connecting end face 10B of the ferrule body 10 is inclined with respect to a plane perpendicular to the optical axis of the optical fiber 1, and the bottom surface of the recessed portion 15 and the film 20 are arranged parallel to the connecting end face 10B. As a result, the film 20 can be arranged in the recessed portion 15 such that the film 20 does not protrude from the connecting end face 10B of the ferrule body 10.

Also, in one or more embodiments, the optical axis of the optical fiber of the another ferrule is arranged on an extension line of the optical axis of the optical fiber 1. In other words, in one or more embodiments, as shown in FIG. 3A, the position of the optical axis of the optical fiber 1 is not offset in the up-down direction (thickness direction). Because the air gap between the ferrule 100 of one or more embodiments and the another ferrule is small, connection loss can be suppressed even if the position of the optical axis of the optical fiber 1 is not offset in the up-down direction (thickness direction). By arranging the optical fiber 1 so that the position of the optical axis is not offset in the up-down direction (thickness direction), optical fibers can be optically connected to each other even if the connection target is the PC-type ferrule 100′.

Note that if there is an offset in the up-down direction of the optical fiber, the optical fiber of the another ferrule also needs to be offset in the up-down direction, and therefore the ferrule of one or more embodiments cannot be connected to a PC-type ferrule. However, if the ferrule of one or more embodiments is not connected to a PC-type ferrule, the optical axis of the optical fiber may be offset in the up-down direction in consideration of refraction of the optical signal in the air gap.

Also, in one or more embodiments, the ferrule body 10 has the pair of guide holes 11, and when the ferrule body 10 is viewed from the front side, the fiber holes 12 are arranged point-symmetrically about the center point between the pair of guide holes 11. As a result, the optical axis of the optical fiber of the another ferrule is arranged on an extension line of the optical axis of the optical fiber 1. In other words, this makes it possible to achieve an aspect in which the position of the optical axis of the optical fiber 1 is not offset in the up-down direction (thickness direction).

Note that in one or more embodiments, the film 20 is arranged in a position where the outward surface of the film 20 is recessed from the connecting end face 10B of the ferrule body 10. For this reason as well, when the ferrule 100 is connected to the another ferrule (when the connecting end face 10B of the ferrule body 10 is brought into contact with the connecting end face of the another ferrule), the film 20 does not come into contact with the another ferrule, and therefore damage to the film 20 can be suppressed.

### Manufacturing Method for Ferrule with a Fiber

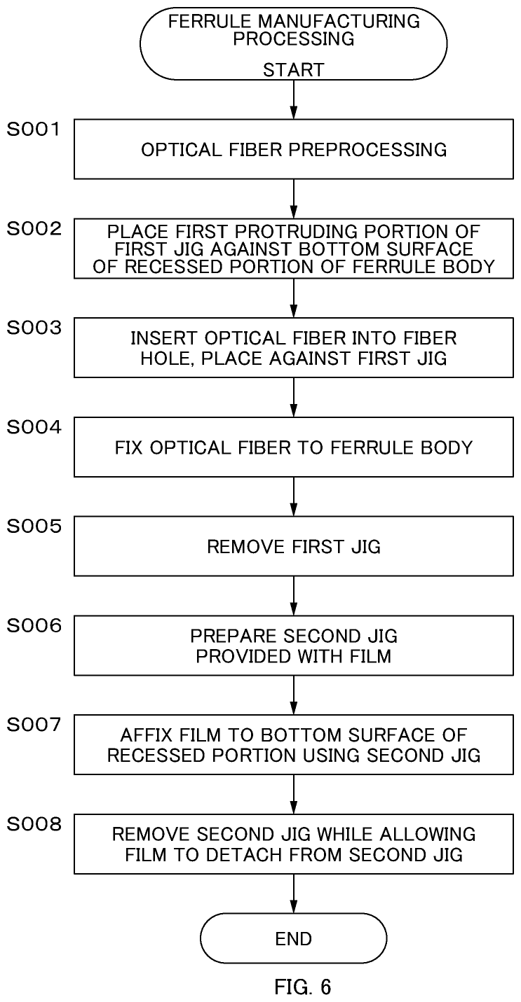

FIG. 6 is a flowchart of a manufacturing process for a ferrule with a fiber of one or more embodiments.

First, an operator performs preprocessing on the optical fibers 1 (step S001). Specifically, the coating of each of the optical fibers 1 constituting the optical fiber ribbon (optical fiber tape) is removed, and the end portions of the optical fibers 1 are cut such that the bare fibers have a predetermined length. In one or more embodiments, the end portion of each of the optical fibers 1 is laser-cut (or the end face of the optical fiber 1 is obliquely polished) such that the end face of the optical fiber 1 is inclined at a predetermined angle.

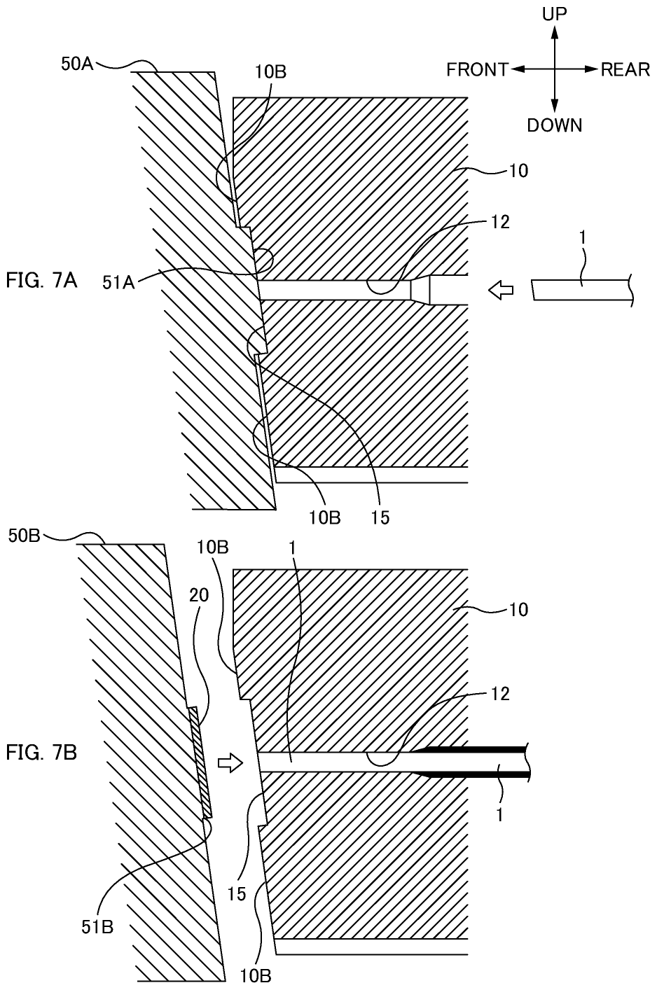

FIG. 7A is a diagram illustrating the processing of steps S002 and S003.

The operator prepares a first jig 50A and the ferrule body 10, and places a first protruding portion 51A of the first jig 50A against the bottom surface of the recessed portion 15 of the ferrule body 10 (step S002). The first protruding portion 51A is formed on the end face of the first jig 50A. The first protruding portion 51A of the first jig 50A is a portion that protrudes from the end face of the first jig 50A along the left-right direction. The first protruding portion 51A is configured to be able to be inserted into the recessed portion 15, and faces the fiber holes 12. The end face of the first protruding portion 51A is configured to be parallel to the bottom surface of the recessed portion 15, and the height (protrusion amount) of the first protruding portion 51A is set to be slightly higher than the depth of the recessed portion 15 of the ferrule body 10. Therefore, the end face of the first protruding portion 51A can abut against the bottom surface of the recessed portion 15. When the end face of the first protruding portion 51A abuts against the bottom surface of the recessed portion 15, the fiber holes 12 of the ferrule body 10 are closed by the end face of the first protruding portion 51A.

Next, as shown in FIG. 7A, the operator inserts the optical fibers 1 into the fiber holes 12 of the ferrule body 10, and places the end faces of the optical fibers 1 against the end face of the first jig 50A (specifically, the end face of the first protruding portion 51A) (step S003). Note that in one or more embodiments, the operator matches the direction of the inclined end faces of the optical fibers 1 with the direction of the connecting end face 10B (inclined end face) of the ferrule body 10 when inserting the optical fibers 1 into the fiber holes 12 of the ferrule body 10. Due to placing the end faces of the optical fibers 1 against the first jig 50A, the optical fibers 1 are positioned in the front-rear direction with respect to the ferrule body 10.

If the end faces of the optical fibers 1 are placed against the film 20 in the state where the film 20 has been attached, the thin and flexible film 20 may be damaged. In particular, if the end faces of the optical fibers 1 are inclined, the film 20 can easily be damaged when the inclined end faces of the optical fibers 1 are placed against the film 20. However, in one or more embodiments, as shown in FIG. 7A, the optical fiber 1 is positioned by placing the end faces of the optical fibers 1 against the first jig 50A before attaching the film 20 to the ferrule body 10. Therefore, it is not necessary to place the end faces of the optical fibers 1 against the film 20.

Next, the operator fixes the optical fibers 1 to the ferrule body 10 (step S004). Here, after the end faces of the optical fibers 1 have been placed against the first jig 50A, the adhesive filling portion 13 of the ferrule body 10 is filled with an adhesive, and the optical fibers 1 are bonded to the ferrule body 10. After fixing the optical fibers 1, the operator removes the first jig 50A from the ferrule body 10 (step S005). At this stage, the end faces of the optical fibers 1 are arranged in the openings of the fiber holes 12 of the ferrule body 10 (the openings at the bottom surface of the recessed portion 15). In other words, the bottom surface of the recessed portion 15 and the end faces of the optical fibers 1 are arranged on the same plane.

FIG. 7B is a diagram illustrating the processing of steps S006 and S007.

The operator prepares a second jig 50B that is arranged with the film 20 (step S006). A second protruding portion 51B is formed on the end face of the second jig 50B, and the film 20 is detachably attached to the end face of the second protruding portion 51B. The second protruding portion 51B is a portion that protrudes from the end face of the second jig 50B along the left-right direction. The second protruding portion 51B is configured to be able to be inserted into the recessed portion 15, and the film 20 attached to the second protruding portion 51B faces the fiber holes 12. The end face of the second protruding portion 51B is configured to be parallel to the bottom surface of the recessed portion 15, and the film 20 attached to the second protruding portion 51B is also arranged parallel to the bottom surface of the recessed portion 15. The height (protrusion amount) of the second protruding portion 51B is lower than that of the first protruding portion 51A, and is set to about 0.005 mm here. The sum of the height of the second protruding portion 51B and the thickness of the film 20 is approximately the same as the depth of the recessed portion 15.

Next, as shown in FIG. 7B, the operator affixes the film 20 to the bottom surface of the recessed portion 15 with use of the second jig 50B (step S007). The film 20 is affixed to the bottom surface of the recessed portion 15 with use of an adhesive that acts as a refractive index matching material and has been applied to at least either the rear surface of the film 20 (the surface on the ferrule body 10 side) or the end faces of the optical fibers 1. Accordingly, the film 20 is arranged in the recessed portion 15, the fiber holes 12 that are open at the bottom surface of the recessed portion 15 are covered with the film 20, and the end faces of the optical fibers 1 inserted into the fiber holes 12 are covered with the film 20. Also, the refractive index matching material (adhesive) is arranged between the end faces of the optical fibers 1 and the film 20.

In one or more embodiments, the film 20 is pressed by the second jig 50B against the bottom surface of the recessed portion 15 via the second protruding portion 51B. For this reason, when arranged in the recessed portion 15, the film 20 does not protrude from the connecting end face 10B of the ferrule 100, and the surface of the film 20 is recessed from the connecting end face 10B of the ferrule 100.

It is also possible to affix the film 20 to the bottom surface of the recessed portion 15 without using the second jig 50B. However, if the film 20 is bent when the film 20 is attached, the thin and flexible film 20 may be damaged. In particular, in the case where the film 20 is coated with the antireflection film 21, if the film 20 is deformed when the film 20 is attached, the antireflection film 21 may be damaged. However, in one or more embodiments, due to using the second jig 50B, deformation of the film 20 is suppressed when the film 20 is affixed to the bottom surface of the recessed portion 15. As a result, damage to the film 20 and the antireflection film 21 can be suppressed.

Note that in the case where the film 20 has the antireflection film 21, the antireflection film 21 is arranged on the second jig 50B side when the film 20 is attached to the second jig 50B. As a result, when the film 20 is affixed to the bottom surface of the recessed portion 15, the antireflection film 21 can be arranged on the outward surface side of the film 20.

After the film 20 is adhered to the bottom surface of the recessed portion 15, the operator removes the second jig 50B while allowing the film 20 to detach from the second jig 50B (specifically, the second protruding portion 51B) (step S008). As a result, the ferrule 100 of one or more embodiments is completed.

According to the ferrule manufacturing method of one or more embodiments, the ferrule body 10 is prepared, the first jig 50A is placed against the bottom surface of the recessed portion 15 of the ferrule body 10 (step S002), the end face of the optical fiber 1 inserted into the fiber hole 12 is placed against the first jig 50A (step S003), the optical fiber 1 is fixed to the ferrule body 10 (step S004), and then the film 20 is attached to the bottom surface of the recessed portion 15 after the first jig 50A has been removed (step S007). As a result, in one or more embodiments, it is not necessary to place the end face of the optical fiber 1 against the film 20, and therefore damage to the film 20 can be suppressed.

Also, according to the ferrule manufacturing method of one or more embodiments, the film 20 is affixed to the bottom surface of the recessed portion 15 with use of the second jig 50B. As a result, deformation of the film 20 can be suppressed, and therefore damage to the film 20 can be suppressed. Note that the method of affixing the film 20 to the bottom surface of the recessed portion 15 with use of the second jig 50B in this way is particularly effective in the case where the film 20 is arranged with the antireflection film 21.

Also, according to the ferrule manufacturing method of one or more embodiments, the film 20 is detachably attached to the end face of the second protruding portion 51B of the second jig 50B (see FIG. 7B), and the film 20 is pressed by the second jig 50B against the bottom surface of the recessed portion 15 via the second protruding portion 51B. As a result, the film 20 arranged in the recessed portion 15 does not protrude from the connecting end face 10B of the ferrule 100, and the surface of the film 20 is recessed from the connecting end face 10B of the ferrule 100.

### Variation

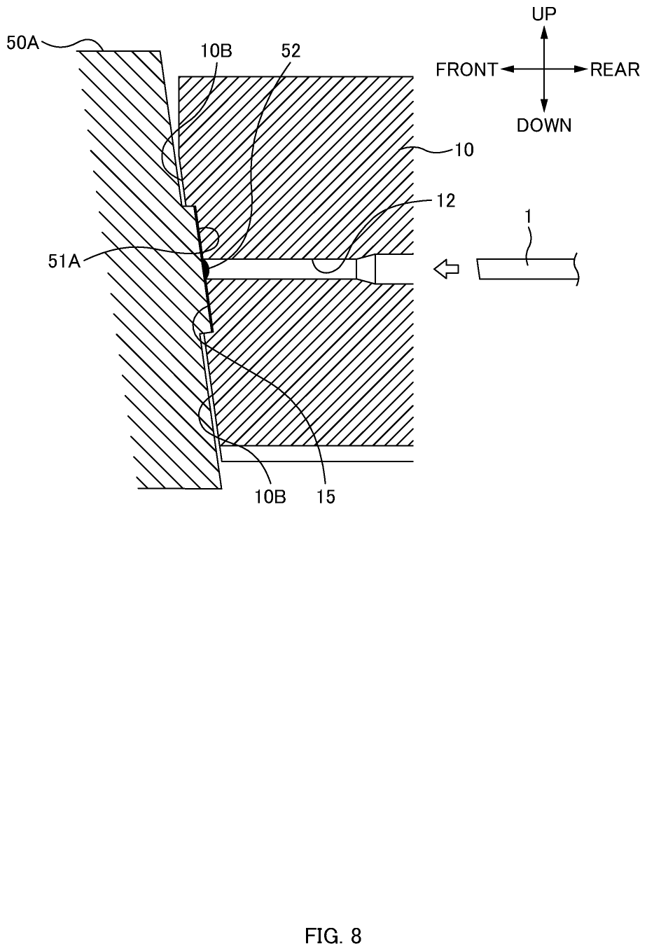

FIG. 8 is a diagram illustrating the processing of steps S002 and S003 in a variation.

The operator prepares the first jig 50A on which a solid refractive index matching material 52 has been arranged. The solid refractive index matching material 52 is a light-transmitting member that has a refractive index suitable for the optical fiber 1 and is a deformable (plastically deformable) solid member. Examples of the material of the solid refractive index matching material 52 include acrylic-based, epoxy-based, vinyl-based, silicone-based, rubber-based, urethane-based, methacrylic-based, nylon-based, bisphenol-based, diol-based, polyimide-based, fluorinated epoxy-based, and fluorinated acrylic-based polymer materials. The sheet-shaped solid refractive index matching material 52 has been affixed in advance to the end face of the first protruding portion 51A of the first jig 50A.

In step S002, when the first protruding portion 51A of the first jig 50A is placed against the bottom surface of the recessed portion 15 of the ferrule body 10, the solid refractive index matching material 52 deforms, and the solid refractive index matching material 52 enters the space inside the fiber hole 12 as shown in FIG. 8. Then, in step S003, the optical fiber 1 is inserted into the fiber hole 12 of the ferrule body 10, and the end face of the optical fiber 1 is placed against the first jig 50A (specifically, the end face of the first protruding portion 51A) via the solid refractive index matching material 52. Note that the solid refractive index matching material 52 is made of a brittle material, and when the first jig 50A is removed in step S005, the portion of the solid refractive index matching material 52 that has entered the fiber hole 12 stays attached to the surface of the end face of the optical fiber 1 and remains in the fiber hole 12. Accordingly, when the film 20 is subsequently affixed to the bottom surface of the recessed portion 15, the solid refractive index matching material 52 can fill the space between the film 20 and the end face of the optical fiber 1.

Note that instead of affixing the solid refractive index matching material 52 to the end face of the first protruding portion 51A of the first jig 50A, a configuration is possible in which the solid refractive index matching material 52 is laminated in advance on the inward surface (the ferrule body 10 side) of the film 20, and the film 20 with the solid refractive index matching material 52 laminated thereon is affixed to the bottom surface of the recessed portion 15.

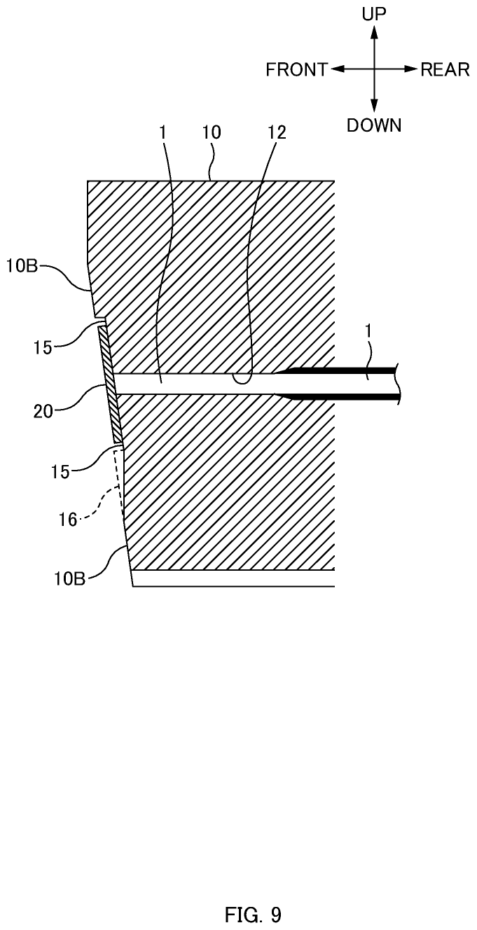

FIG. 9 is an enlarged cross-sectional view of the vicinity of the connecting end face 10B of the ferrule 100 according to one or more embodiments.

Compared with the previously described embodiments shown in FIG. 2B, the ferrule 100 of one or more embodiments is different in that there is no dotted line portion indicated by reference numeral 16. Specifically, in the ferrule 100 of one or more embodiments, the portion of the connecting end face 10B below the recessed portion 15 is configured so as not to project forward from the bottom surface of the recessed portion 15. According to this configuration, when the ferrule body 10 is molded with resin, the mold for forming the bottom surface of the recessed portion 15 can be pulled out downward relative to the ferrule body 10.

Note that in one or more embodiments, the film 20 is arranged to cover the fiber holes 12 that are open at the bottom surface of the recessed portion 15. For this reason, the end faces of the optical fibers 1 are covered with the film 20, and therefore damage to the end faces of the optical fibers 1 can be suppressed. Also, in one or more embodiments, the film 20 is formed thinner than the depth of the recessed portion 15. In other words, in one or more embodiments, the outward surface of the film 20 is arranged at a position recessed from the connecting end face 10B of the ferrule body 10. As a result, when the ferrule 100 is connected to the another ferrule (when the connecting end face 10B of the ferrule body 10 is brought into contact with the connecting end face of the another ferrule), the film 20 does not come into contact with the another ferrule, and therefore damage to the film 20 can be suppressed. Note that in one or more embodiments, similarly to the previously described embodiment, the film 20 is arranged on the front side of the end face of the optical fiber 1, and therefore the air gap between the ferrule and the another ferrule can be smaller than in the comparative example in which the film 20 is not arranged (see FIGS. 4A and 4B), and therefore connection loss can be suppressed.

Other Remarks

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### LIST OF REFERENCE NUMERALS

1 optical fiber, 10 ferrule body,
10A flange portion, 10B connecting end face,
11 guide hole, 12 fiber hole,
13 adhesive filling portion, 14 introduction hole,
15 recessed portion, 16 spot face portion,
20 film, 21 antireflection film,
30 boot,
50A first jig, 50B second jig,
51A first protruding portion, 51B second protruding portion,
52 solid refractive index matching material, 100 ferrule

1. A ferrule comprising:
a ferrule body comprising:
a connecting end face that connects to another ferrule;
a fiber hole into which an optical fiber is inserted; and
a recessed portion that is recessed from the connecting end face; and
a film that covers the fiber hole that is open at a bottom surface of the recessed portion,
wherein the film is thinner than a depth of the recessed portion.

2. The ferrule according to claim 1, wherein the film is coated with an antireflection film.

3. The ferrule according to claim 1,
wherein the connecting end face is inclined with respect to a plane perpendicular to an optical axis of the optical fiber to be inserted into the fiber hole, and
wherein the bottom surface of the recessed portion and the film are disposed parallel to the connecting end face.

4. The ferrule according to claim 1,
wherein an optical axis of an optical fiber of the another ferrule is disposed on an extension line of the optical axis of the optical fiber to be inserted into the fiber hole.

5. The ferrule according to claim 1,
wherein the ferrule body has a pair of guide holes into which guide pins are inserted, and
wherein a plurality of the fiber holes are disposed point-symmetrically about a center point between the pair of guide holes.

6. A ferrule comprising:
a ferrule body having a connecting end face that connects to another ferrule, a fiber hole into which an optical fiber is inserted, and a recessed portion that is recessed from the connecting end face; and
a film that covers the fiber hole that is open at a bottom surface of the recessed portion, an outward surface of the film being recessed from the connecting end face.

7. A ferrule manufacturing method for manufacturing a ferrule comprising a connecting end face that connects to another ferrule, a fiber hole into which an optical fiber is inserted, and a recessed portion that is recessed from the connecting end face, the method comprising:
placing a first jig against a bottom surface of the recessed portion of the ferrule body;
inserting the optical fiber into the fiber hole and placing an end face of the optical fiber against the first jig;
fixing the optical fiber to the ferrule body in a state where the end face of the optical fiber is placed against the first jig; and
attaching a film to the bottom surface of the recessed portion such that the film covers the fiber hole that is open at the bottom surface of the recessed portion after the first jig has been removed.

8. The ferrule manufacturing method according to claim 7,
wherein the attaching of the film includes:
preparing a second jig to which the film is detachably attached;
affixing the film to the bottom surface of the recessed portion using the second jig; and
removing the second jig while allowing the film to detach from the second jig.

9. The ferrule manufacturing method according to claim 8,
wherein the film is coated with an antireflection film.

10. The ferrule manufacturing method according to claim 8, further comprising:
detachably attaching the film to an end face of a protruding portion of the second jig; and
pressing the film by the second jig against the bottom surface of the recessed portion via the protruding portion.
